(19) United States
(12) Patent Application Publication
(10) Pub. No.: US 2016/0290032 A1
(43) Pub. Date: Oct. 6, 2016

(54) SPACER FOR INSULATING GLAZING UNITS, COMPRISING EXTRUDED PROFILED SEAL

(71) Applicant: SAINT-GOBAIN GLASS FRANCE, Courbevoie (FR)

(72) Inventors: Hans-Werner KUSTER, AACHEN (DE); Walter SCHREIBER, AACHEN (DE); Rino MESSERE, MODAVE (BE)

(21) Appl. No.: 15/038,298

(22) PCT Filed: Dec. 5, 2014
(86) PCT No.: PCT/EP2014/076739

§ 371 Date: May 20, 2016

(30) Foreign Application Priority Data
Dec. 12, 2013 (EP) 13196865.3

(51) Int. Cl. E06B 3/663; E06B 3/673

(52) U.S. Cl. CPC E06B 3/66328; E06B 3/66319; E06B 3/6733; E06B 3/66366; E06B 3/6715

(57) ABSTRACT

A spacer for insulating glazing units is described. The sealing arrangement includes a polymer base; which includes two pane contact surfaces, a glazing interior space surface and an outer surface and an extruded profiled seal on the outer surface, the extruded profiled seal and the polymer base being co-extruded.

The invention relates to a spacer with an extruded profiled seal, a method for its production, and its use.

The thermal conductivity of glass is lower by roughly a factor of 2 to 3 than that of concrete or similar building materials. However, since, in most cases, panes are designed significantly thinner than comparable elements made of brick or concrete, buildings frequently lose the greatest share of heat via external glazing. This effect is particularly significant in high-rise buildings with partial or complete glass facades. The increased costs necessary for heating and air-conditioning systems make up a part of the maintenance costs of the building that must not be underestimated. Moreover, as a consequence of more stringent construction regulations, lower carbon dioxide emissions are required. An important approach to a solution for this involves insulating glazing units, without which, primarily as a result of increasingly rapidly rising prices of raw materials and more stringent environmental protection constraints, it is no longer possible to imagine the building construction sector.

Insulating glazing units are manufactured from at least two panes that are connected to each other via at least one circumferential spacer. Depending on the embodiment, the interpane space between the two panes, referred to as the “glazing interior”, is filled with air or gas, but in any case free of moisture. An excessive moisture content in the interpane space of the glazing results, in particular in the case of cold exterior temperatures, in the condensation of drops of water in the interpane space, which absolutely must be avoided. To absorb the residual moisture remaining in the system after assembly, hollow body spacers filled with a desiccant can, for example, be used. However, since the absorption capacity of the desiccant is limited, even in this case, the sealing of the system is of enormous importance to prevent the penetration of additional moisture. In the case of gas-filled insulating glazing units, into whose glazing interior an argon filling, for example, is introduced, gas tightness must also be ensured.

In order to ensure improved leak tightness of insulating glazing units, greatly varied modifications in the field of the spacers are already known. Already in DE 40 24 697 A1, the problem is discussed that customary single or double sealed insulating glass edge bonds made of materials such as polysulfide polymers, butyl hot melt, silicone rubber, polymercaptan, or polyurethane cannot ensure long-term adequate sealing and, over time, an undesirable gas exchange between the glazing interior and the environment occurs.

Improved sealing is accomplished according to DE 40 24 697 A1 by means of a modification of the spacer, onto whose pane contact surfaces polyvinylidene chloride films or coatings are applied.

Another measure for improving the leak tightness of insulating glazing units is the coating of polymeric spacers with metal foils or alternating metal polymer layer systems, as disclosed, for example, in EP 0 852 280 A1 and WO 2013/104507 A1. These ensure high leak tightness of the spacer with simultaneous compatibility with the sealing materials used for assembly.

Despite these improvements in the field of spacers, leak tightness problems upon failure of the sealant between spacers and adjacent panes persist. According to the prior art, only this sealant is watering gas impermeable, whereas the outer seal of the insulating glazing unit is accomplished with materials such as silicon or polysulfide, which have very good adhesion properties but are water and gas permeable. The outer seal thus serves primarily for mechanical stability of the glazing unit. Accordingly, a defect of the sealant between the spacers and the panes results in complete failure of the insulating glazing unit. Even the prior improvements in the field of spacers, such as coated polymeric spacers, do not help since the coating seals only the spacer itself but not the glazing interior.

The object of the present invention is to provide a spacer, which results in improved sealing of insulating glazing units, an insulating glazing unit with this spacer, as well as an economical method for producing the insulating glazing unit.

The object of the present invention is accomplished according to the invention by a spacer, an insulating glazing unit with a spacer, a method for its production, and the use of the spacer according to independent claims 1, 9, 14, and 15. Preferred embodiments of the invention emerge from the subclaims.

The spacer according to the invention for insulating glazing units comprises at least a polymeric main body and an extruded profiled seal. The polymeric main body comprises two pane contact surfaces, a glazing interior surface, and an outer surface, with the extruded profiled seal applied on the outer surface of the polymeric main body. As a result of the fact that the main body and the profiled seal are coextruded, the extruded profiled seal is formed in one piece with the polymeric main body. This is particularly advantageous since the profiled seal does not have to be introduced in a separate step in the glazing plant, but, instead, the component made up of the main body and the profiled seal is already available in ready to install form. This saves time in the production process as a result of which production costs can be reduced. Since the spacer according to the invention is produced independent of the insulating glazing unit assembly line and no modifications of the production plant are required for installation of the spacer, the spacer according to the invention is universally usable without added expense. Moreover, the extruded profiled seal ensures reliable and durable sealing of the outer surface of the spacer.

Films for sealing the spacer, as known in the prior art, are, as a rule, fixed on the spacer using an adhesive, with an adhesive failure due to aging of the adhesive possibly resulting in leaks of the spacer. The coextruded spacer according to the invention is formed in one piece such that adhesive bonding is eliminated and such a failure can be avoided.

The spacer according to the invention includes, in a preferred embodiment, no additional polymeric or metallic layers, such as an insulating film, on its exterior. This is particularly advantageous since the production of the spacer according to the invention is substantially simpler and more cost-effective than coating with an insulating film, especially than coating with an insulating film with alternating metallic and polymeric layers, as is used according to the prior art in order to ensure adequate leak tightness.

The extruded profiled seal preferably protrudes laterally beyond the pane contact surfaces of the spacer. Particularly preferably, the extruded profiled seal protrudes by 0.1 mm to 2 mm, preferably 0.5 mm to 1 mm, beyond the first pane contact surface and/or the second pane contact surface. Thus, after installation of the spacer, the extruded profiled seal makes contact with the adjacent panes of the insulating glazing unit and seals the glazing interior. In order to ensure uniform centering of the spacer in the interpane space, the extruded profiled seal protrudes, preferably on the two pane contact surfaces, by the same amount beyond the polymeric main body. As a result of the flexibility of the extruded profiled seal, precisely fitted installation as well as accurate sealing are possible. Insulating films known in the prior art that are applied on the spacer cannot provide such sealing.

The two pane contact surfaces of the polymeric main body comprise a first pane contact surface and a second pane contact surface. The first pane contact surface and the second pane contact surface are the sides of the main body, onto which, at the time of installation of the spacer, the fixing of the panes (first pane and second pane) of an insulating glazing unit is done. The first pane contact surface and the second pane contact surface run parallel to each other.

The glazing interior surface is defined as the surface of the polymeric main body that faces in the direction of the interior of the glazing after installation of the spacer in an insulating glazing unit. The glazing interior surface is between the panes mounted on the spacer.

The outer surface of the polymeric main body is the side opposite the glazing interior surface, which faces away from the interior of the insulating glazing unit in the direction of an external interpane space. The outer surface preferably runs perpendicular to the pane contact surfaces. However, the outer surface nearest the pane contact surfaces can, alternatively, be inclined at an angle of preferably 30° to 60° relative to the outer surface in the direction of the pane contact surfaces. This angled geometry improves the stability of the polymeric main body. A planar outer surface, which remains perpendicular to the pane contact surfaces over its entire course has, in contrast, the advantage that the sealing surface between spacers and pane contact surfaces is maximized and simpler shaping facilitates the production process.

The spacer preferably has, along the pane contact surfaces, a height of 5 mm to 15 mm, particularly preferably of 5 mm to 10 mm.

The width of the glazing interior surface, which defines the distance between the first pane and the second pane, is 4 mm to 30 mm, preferably 8 mm to 16 mm.

The profiled seal extruded on the outer surface of the polymeric main body contains butyl rubber, polyisobutylene, polyethylene vinyl alcohol, ethylene vinyl acetate, polyolefin rubber, polypropylene, polyethylene, copolymers, and/or mixtures thereof. These materials are particularly advantageous since they are gas- and watertight and the polymeric main body as well as the glazing interior are thus sealed against the entry of atmospheric moisture as well as the escape of a filling gas (if present).

In a preferred embodiment, the penetration index of the extruded profiled seal is between 20 and 40, particularly preferably between 30 and 40. All data used here refer to the penetration index per ISO 2137-DIN 5180 measured at a temperature of 60° C. The penetration index is a measure of the hardness of the material. Accordingly, a material with a small penetration index is harder than a material with a large penetration index. Here, the selection of a harder material for producing the extruded profiled seal is particularly advantageous in order to achieve a reliable seal even at high temperatures. Soft materials with high penetration indices start to flow in the case of strong heating, as a result of which the individual components of the insulating glazing unit can shift relative to each other and/or a failure of the seal can occur. Through the use of a harder sealant material, this is prevented.

The thickness of the extruded profiled seal is 0.5 mm to 5 mm, preferably 1 mm to 2 mm.

The polymeric main body contains polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

Preferably, the polymeric main body is glass fiber reinforced. By means of the selection of the glass fiber content in the main body, the coefficient of thermal expansion of the main body can be varied and adapted. Through adaptation of the coefficient of thermal expansion of the polymeric main body and of the extruded profiled seal, temperature-related stresses between the various materials and flaking of the extruded profiled seal can be prevented. This is the case particularly with hard materials with a low penetration index, such as, for example, polypropylene or polyethylene. The main body preferably has a glass fiber content of 20% to 50%, particularly preferably of 30% to 40%. The glass fiber content in the polymeric main body simultaneously improves strength and stability.

Preferably, the polymeric main body is designed as a hollow profile, with, on the one hand, a weight reduction compared to a solidly formed spacer being possible, and, on the other, a hollow chamber being available in the interior of the main body to accommodate additional components, such as, a desiccant.

In a preferred embodiment, the glazing interior surface has at least one opening. Preferably, a plurality of openings are made. The total number of openings depends on the size of the insulating glazing unit. The openings connect the hollow chamber to the interpane space, as a result of which a gas exchange is possible therebetween. This enables absorption of atmospheric moisture by a desiccant situated in the hollow chambers and thus prevents fogging of the pane. The openings are preferably implemented as slits, particularly preferably as slits with a width of 0.2 mm and a length of 2 mm. The slits ensure optimal air exchange without the desiccant being able to penetrate out of the hollow chambers into the interpane spaces.

The polymeric main body preferably contains a desiccant, preferably silica gels, molecular sieves, CaCl₂, Na₂SO₄, activated carbon, silicates, bentonites, zeolites, and/or mixtures thereof. The desiccant ist preferably incorporated into the main body. The desiccant is particularly preferably situated in the hollow chamber of the main body.

The invention further includes an insulating glazing unit with a spacer according to the invention. The insulating glazing unit comprises at least one first pane, a second pane, and a circumferential spacer according to the invention surrounding the panes. The glazing interior of the insulating glazing unit is situated adjacent the glazing interior surface of the spacer. On the other hand, the outer surface of the spacer, on which the extruded profiled seal is fixed, is adjacent the external interpane space. The first pane fixed on the first pane contact surface of the spacer and the second pane on the second contact surface of the spacer.

The two panes are fixed on the pane contact surfaces preferably via a sealant, which is applied between the first pane contact surface and the first pane and/or the second pane contact surface and the second pane.

The sealant preferably contains butyl rubber, polyisobutylene, polyethylene vinyl alcohol, ethylene vinyl acetate, polyolefin rubber, polypropylene, polyethylene, copolymers, and/or mixtures thereof. The sealant is gas- and watertight such that the glazing interior is sealed against the entry of atmospheric moisture as well as the escape of a filling gas (if present).

The sealant is preferably introduced with a thickness of 0.1 mm to 0.8 mm, particularly preferably 0.2 mm to 0.4 mm into the gap between the spacer and the panes.

The external interpane space of the insulating glazing unit is preferably filled with an outer seal. This outer seal serves mainly for the bonding of the two panes and thus for the mechanical stability of the insulating glazing unit.

The outer seal preferably contains polysulfides, silicones, silicone rubber, polyurethanes, polyacrylates, copolymers, and/or mixtures thereof. Such materials have very good adhesion on glass such that the outer seal ensures reliable bonding of the panes.

The thickness of the outer seal is preferably 2 mm to 30 mm, particularly preferably 5 mm to 10 mm.

The insulating glazing unit according to the invention thus includes a triple sealing of the glazing interior consisting of the sealant between the spacer and panes as a primary sealant, the extruded profiled seal on the spacer as a secondary sealant, and the outer seal as a tertiary sealant. An insulating glazing unit according to the prior art includes, in contrast, only one sealant between the spacer and the panes as well as an outer seal and is thus only doubly sealed. However, the outer seal is not a barrier to gases and water vapor such that the seal of a known insulating glazing unit according to the prior art fails completely as soon as the sealant between the spacer and panes has a leak. Even when a spacer according to the prior art additionally includes an insulating film on the exterior of the polymeric main body, this only serves for sealing the spacer and does not contribute to the sealing of the glazing interior. In contrast, the extruded profiled seal of the spacer according to the invention contacts the panes of the insulating glazing unit such that the glazing interior is additionally sealed. Thus, the insulating glazing unit according to the invention has redundant sealing of the glazing interior. In the event of a possible failure of the sealant between the spacer and the panes or a leak of the spacer, the error-free functioning of the insulating glazing unit is thus still ensured. By this means, the service life of the insulating glazing unit according to the invention can be substantially improved compared to the systems known according to the prior art.

The sealant between the spacer and panes has a penetration index of 45 to 100, preferably 50 to 70. The selection of such a soft sealant is, among other things, advantageous in processing. To that end, a strand of the sealant is applied on the pane contact surfaces of the spacer and pressed with the panes. The sealant fills the gap between the panes and the spacer over its entire area. This can be achieved only through the selection of a soft material. Since soft materials with high penetration indices start to flow in the event of strong heating, the individual components of the insulating glazing unit can shift relative to each other and/or a failure of the seal can occur. However, even if the sealant fails, the spacer according to the invention remains fixed in its position by the secondary sealant and the glazing interior remains sealed. Accordingly, the combination of a sealant with a high penetration index and an extruded profiled seal with a lower penetration index enables particularly reliable redundant sealing that withstands even strong heating.

The glazing interior of the insulating glazing unit is preferably filled with a protective gas, preferably with a noble gas, preferably argon or krypton, which reduce the heat transfer value in the insulating glazing unit interpane space.

In a possible embodiment, the insulating glazing unit includes more than two panes.

In that case, for example, a third pane, for example, can be fixed in or on the spacer between the first pane and the second pane. In this embodiment, only a single spacer is used, which bears an extruded profile seal on its exterior.

Alternatively, a plurality of spacers can also be used. In this case, an additional spacer is fixed on the first pane and/or the second pane parallel to the spacer situated between the first and second pane. According to this embodiment, the insulating glazing unit has a plurality of spacers according to the invention with an extruded profiled seal.

The first pane and the second pane of the insulating glazing unit contain glass and/or polymers, preferably quartz glass, borosilicate glass, soda lime glass, polymethyl methacrylate, and/or mixtures thereof. Possible additional panes likewise include these materials, with the composition of the panes also possibly being different.

The panes of the insulating glazing unit according to the invention have a thickness of 1 mm to 50 mm, preferably 3 mm to 16 mm, particularly preferably 3 mm to 10 mm, with the two panes also possibly having different thicknesses.

At the corners of the insulating glazing unit, two spacers provided with a miter cut abut. According to the prior art, these are linked via corner connectors with a gasket to obtain sealing of the frame. Since the spacer according to the invention has an extruded profiled seal, the additional use of corner connectors is unnecessary. The extruded profiled seals of the adjacent spacers have strong reciprocal adhesion such that the extruded profiled seals bond to each other at the abutment site. This yields adequate sealing of the spacer frame profile even without additional measures such as corner connectors.

In the event that redundant sealing is also desired in the region of the corners, in another embodiment, the corners of the insulating glazing unit can be additionally equipped with corner connectors to ensure additional reliability. Alternatively, the corners can also be molded with an additional butyl gasket for this purpose.

Corner connectors can, for example, be implemented as molded plastic parts with a gasket, wherein two spacers provided with a miter cut abut. The corner connectors likewise include, according to the prior art, a gasket which is pressed together at the time of assembly of the individual parts and thus sealed.

In principle, extremely varied geometries of the insulating glazing unit are possible, for example, rectangular, trapezoidal, and rounded shapes. To produce round geometries, the spacer can, for example, be bent in a heated state.

Any abutment sites of the spacer frame profile are, as already discussed for corner connectors, likewise adequately sealed via the extruded profiled seal of the spacer according to the invention. Redundant sealing can also be done at these abutment sites, for example, by molding the abutment sites with an additional butyl gasket.

The invention further includes a method for producing an insulating glazing unit according to the invention comprising the steps:
a) Coextrusion of a spacer composed of a polymeric main body and an extruded profiled seal,
b) Fixing the spacer between a first pane and a second pane via, in each case, a pane contact surface of the spacer by means of a sealant,
c) Pressing the pane arrangement,
d) Introducing an outer seal into the external interpane space.

In step b), the sealant is applied preferably as a strand, for example, with a diameter of 1 mm to 2 mm, on the pane contact surfaces. At the time of the pressing of the pane arrangement, this strand is uniformly distributed in the gap between the pane contact surface and the adjacent pane, resulting in the sealing of the gap.

In step d), the outer seal is preferably extruded directly into the external interpane space.

Preferably, the glazing interior between the panes is filled with a protective gas before the pressing of the arrangement (step c)).

The invention further includes the use of a spacer according to the invention in multiple glazings, preferably in insulating glazing units, particularly preferably in double or triple insulating glazing units. Use in combination with other elements, such as lighting elements, heating elements, antenna elements, or electrically switchable glazings, such as displays or electrochromic glazings, is also possible. In such glazings, a power supply is required in the glazing interior such that an electric conductor, such as a connection element, protrudes from the external interpane space into the glazing interior. In a possible embodiment, the insulating glazing unit has a connection element whose outer end protrudes out of the outer seal and is electrically contactable there and whose inner end contacts the electrically switchable element in the glazing interior. The connection element penetrates through the outer seal, runs between between the extruded profiled seal of the spacer contacting the pane and the adjacent pane and penetrates through the sealant between the pane contact surface and the adjacent pane.

In the following, the invention is explained in detail with reference to drawings. The drawings are purely schematic and not true to scale. They in no way restrict the invention. They depict:

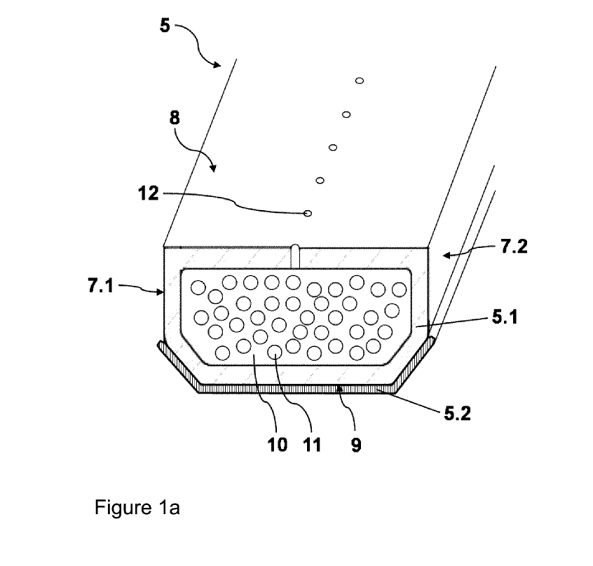

FIG. 1a a schematic representation of the spacer according to the invention,

FIG. 1b a schematic representation of the insulating glazing unit according to the invention with a spacer in accordance with FIG. 1a,

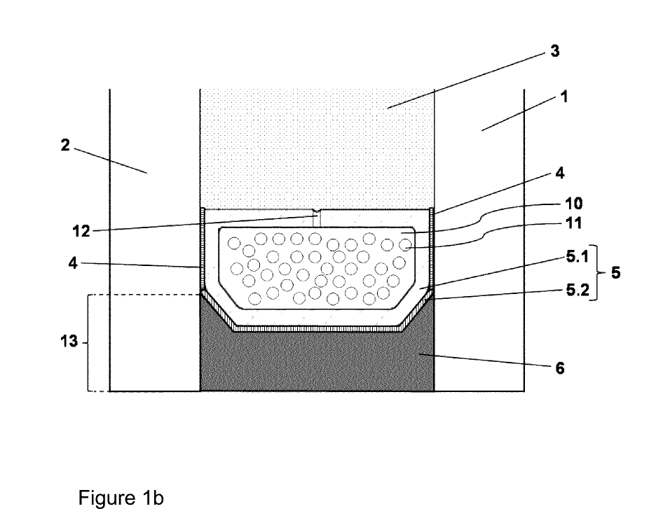

FIG. 2 a flowchart of one possible embodiment of the method according to the invention.

FIG. 1a depicts a schematic representation of the spacer (5) according to the invention comprising a polymeric main body (5.1) and an extruded profiled seal (5.2). The polymeric main body (5.1) is a hollow body profile comprising two pane contact surfaces (7.1, 7.2), a glazing interior surface (8), an outer surface (9), and a hollow chamber (10). The polymeric main body (5.1) contains styrene acrylonitrile (SAN) and roughly 35 wt.-% glass fiber. The outer surface (9) has an angled shape, wherein the sections of the outer surface adjacent the pane contact surfaces (7.1, 7.2) are inclined at an angle of 30° relative to the pane contact surfaces (7.1, 7.2). This improves the stability of the glass fiber reinforced polymeric main body (5.1). The hollow body (10) is filled with a desiccant (11). A molecular sieve is used as the desiccant (11). The glazing interior surface (8) of the spacer (5) has openings (12), which are made at regular intervals circumferentially along the glazing interior surface (8) in order to enable a gas exchange between the interior of the insulating glazing unit and the hollow chamber (10). Thus, atmospheric moisture possibly present in the interior is absorbed by the desiccant (11). The openings (12) are implemented as slits with a width of 0.2 mm and a length of 2 mm. The extruded profiled seal (5.2) is applied on the outer surface (9) of the polymeric main body (5.1), with the polymeric main body (5.1) and the extruded profiled seal (5.2) being coextruded. The extruded profiled seal (5.2) is made of polyisobutylene with a penetration index of 36 and a thickness of 1 mm. The extruded profiled seal (5.2) protrudes beyond the first pane contact surface (7.1) and the second pane contact surface (7.2) by 0.8 mm in each case.

FIG. 1b depicts an insulating glazing unit according to the invention with a spacer in accordance with FIG. 1a. The spacer (5) according to the invention is fixed circumferentially between a first pane (1) and a second pane (2) via a sealant (4). The sealant (4) bonds the pane contact surfaces (7.1, 7.2) of the spacer (5) to the panes (1, 2). The glazing interior (3) adjacent the glazing interior surface (8) of the spacer (5) is defined as the space delimited by the panes (1, 2) and the spacer (5). The external interpane space (13) adjacent the outer surface (9) of the spacer (5) is a strip-shaped circumferential section of the glazing, which is delimited by one side each of the two panes (1, 2) and on another side by the spacer (5) and whose fourth edge is open. The glazing interior (3) is filled with argon. A sealant (4) with a thickness of 0.2 mm is introduced in each case, between a pane contact surface (7.1, 7.2) and the adjacent pane (1, 2), which sealant seals the gap between the pane (1, 2) and the spacer (5). The sealant (4) is polyisobutylene with a penetration index of 50-70. The extruded profiled seal (5.2) contacts the adjacent panes (1, 2), since it protrudes beyond the pane contact surfaces (7.1, 7.2) of the spacer (5), as described in FIG. 1a. An outer seal (6) which serves for the bonding of the first pane (1) and the second pane (2) is fixed on the extruded profiled seal (4) in the external interpane space (13). The outer seal (6) is made of silicone, which is inserted in a thickness of 10 mm into the external interpane space (14). The outer seal (6) ends flush with the pane edges of the first pane (1) and the second pane (2). The outer seal (6) is permeable to gas and water, but is, due to its very good adhesion on glass, of enormous importance for the mechanical stability of the insulating glazing unit. The use of the spacer (5) according to the invention is particularly advantageous since the extruded profiled seal (5.2) is rigid enough to lock the spacer between the panes (1, 2) and thus to fix it in its position even in the event of a possible failure of the sealant (4). On the other hand, the extruded profiled seal (5.2) is flexible enough to give way at the time of pressing of the pane arrangement. Since the extruded profiled seal (5.2) covers the external interpane space (13) over its entire surface and contacts the two panes (1, 2), it also serves for additional sealing of the glazing interior (3) such that its leak tightness can be ensured even in the event of failure of the sealant (4). Thus, the service life of the insulating glazing unit can be decisively increased. At the same time, the spacer (5) according to the invention is simple to use, since the installation of the spacer (5) can be done without modification of the tools and plants used according to the prior art such that no investments are to be made at the time of a changeover in production.

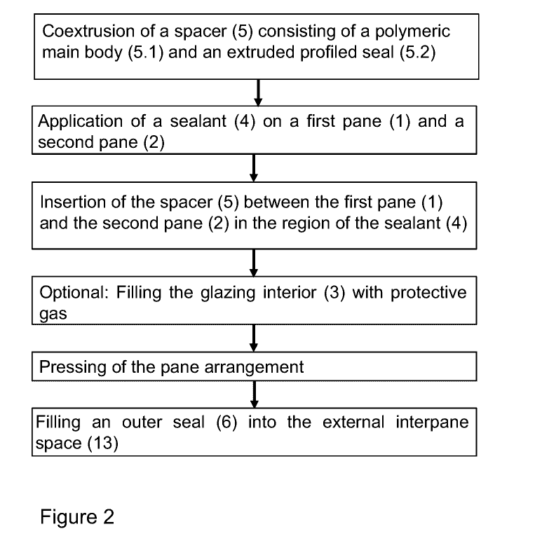

FIG. 3 depicts a flowchart of one possible embodiment of the method according to the invention. First, a spacer (5) composed of a polymeric main body (5) and an extruded profiled seal (5.2) is coextruded. This spacer (5) is fixed via a sealant (4) between a first pane (1) and a second pane (2), with the sealant (4) being introduced between the pane contact surfaces (7.1, 7.2) of the spacer (5) and the panes (1, 2). The glazing interior (3) can optionally be filled with a protective gas. At the time of subsequent pressing of the pane arrangement, the sealant (4) is distributed uniformly in the gap between the spacer (5) and the adjacent pane pane (1, 2) and seals it. The sealant (4) is applied, for example, as a round strand of 1 mm to 2 mm diameter and has, after pressing, a thickness of, for example, 0.2 mm. To support such processing, it is advantageous to use a soft material with a penetration index of 45 to 100 as sealant (4). Then, an outer seal (6) is introduced adjacent the extruded profiled seal (5.2) into the external interpane space (13), with the outer seal (6) ending flush with the edges of the panes (1, 2). The outer seal (6) is preferably extruded directly into the external interpane space (13).

### LIST OF REFERENCE CHARACTERS

1 first pane

2 second pane

3 glazing interior

4 sealant

5 spacer

5.1 polymeric main body

5.2 extruded profiled seal

6 outer seal

7 pane contact surfaces

7.1 first pane contact surface

7.2 second pane contact surface

8 glazing interior surface

9 outer surface

10 hollow chamber

11 desiccant

12 openings

13 external interpane space

1.-15. (canceled)

16. A spacer for insulating glazing units, comprising:
a polymeric main body comprising two pane contact surfaces, a glazing interior surface, and an outer surface, and
an extruded profiled seal on the outer surface,
wherein the extruded profiled seal and the polymeric main body are coextruded.

17. The spacer according to claim 16, wherein the extruded profiled seal contains a component selected from the group consisting of butyl rubber, polyisobutylene, polyethylene vinyl alcohol, ethylene vinyl acetate, polyolefin rubber, polypropylene, polyethylene, copolymers, and/or mixtures thereof.

18. The spacer according to claim 16, wherein the extruded profiled seal protrudes laterally beyond at least one of the pane contact surfaces of the polymeric main body.

19. The spacer according to claim 16, wherein the thickness of the extruded profiled seal is 0.5 mm to 5 mm.

20. The spacer according to claim 16, wherein the polymeric main body contains components selected from the group consisting of polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

21. The spacer according to claim 16, wherein the polymeric main body includes at least one hollow chamber.

22. The spacer according to claim 21, wherein the glazing interior surface has one or more openings connecting the hollow chamber to a glazing interior.

23. The spacer according to claim 16, wherein the polymeric main body contains a desiccant.

24. An insulating glazing unit comprising
a first pane,
a second pane,
the spacer of claim 16, the spacer being a circumferential spacer surrounding the first pane and the second pane,
a glazing interior adjacent the glazing interior surface of the spacer, and
an external interpane space adjacent the outer surface of the spacer,
wherein:
the first pane contacts a first pane contact surface of the spacer, and
the second pane contacts a second pane contact surface of the spacer.

25. The insulating glazing unit according to claim 24, further comprising
a sealant between the first pane contact surface and the first pane and/or the second pane contact surface and the second pane.

26. The insulating glazing unit according to claim 24, further comprising an outer seal inserted in the external interpane space.

27. The insulating glazing unit according to claim 26, wherein the outer seal contains a component selected from the group consisting of polysulfides, silicones, silicone rubber, polyurethanes, polyacrylates, copolymers, and/or mixtures thereof.

28. The insulating glazing unit according to claim 24, wherein the first pane and the second pane contain glass and/or polymers.

29. A method for producing the insulating glazing unit according to claim 24, comprising:
coextruding a spacer consisting of a polymeric main body and an extruded profiled seal,
fixing the spacer by way of a sealant via a pane contact surface between a first pane and a second pane,
performing a pressing operation, and
introducing an outer seal into the external interpane space.

30. A plurality of glazing units comprising the spacer according to claim 16.
